(19) United States
(12) Patent Application Publication
(10) Pub. No.: US 2008/0055949 A1
(43) Pub. Date: Mar. 6, 2008

(54) SYSTEM INTERCONNECTION INVERTER

(75) Inventors: Koji Noda, Fuji-shi (JP); Michika Uesugi, Fuji-shi (JP); Takahisa Endo, Fuji-Shi (JP); Keiichi Ishida, Fuji-shi (JP)

Correspondence Address: DLA PIPER US LLP, P. O. BOX 9271, RESTON, VA, 20195, US

(73) Assignee: TOSHIBA CARRIER CORPORATION, MINATO-KU (JP)

(21) Appl. No.: 11/778,730

(22) Filed: Jul. 17, 2007

(30) Foreign Application Priority Data
Aug. 29, 2006 (JP) 2006-232620

(51) Int. Cl. H02M 7/538

(52) U.S. Cl. 363/95

(57) ABSTRACT

Each time a system interconnection inverter is booted up, a control program, which is stored in a remote-controller, is downloaded and stored in a RAM in a main body side. When the system interconnection inverter is halted, the control program in the RAM is lost.

### CROSS-REFERENCE TO RELATED APPLICATIONS

This application is based upon and claims the benefit of priority from prior Japanese Patent Application No. 2006-232620, filed Aug. 29, 2006, the entire contents of which are incorporated herein by reference.

### BACKGROUND OF THE INVENTION

1. Field of the Invention

The present invention relates to a system interconnection inverter which converts a generated output of, e.g. a solar battery to an AC, and outputs the AC to a commercial power supply system in a system-interconnection manner.

2. Description of the Related Art

As a power supply system which converts a DC voltage to an AC and supplies the AC to a load, there is known a system interconnection inverter which converts an output of a solar battery to an AC and outputs the AC to a commercial power supply system in a system-interconnection fashion (see, e.g. Jpn. Pat. Appln. KOKAI Publication No. 2005-94253, Jpn. Pat. Appln. KOKAI Publication No. 6-165392 and Jpn. Pat. Appln. KOKAI Publication No. 2004-350429). A control unit is mounted in this system interconnection inverter, and a control program for executing a system interconnection control is stored in a memory of the control unit.

In many cases, the system interconnection inverter is installed outdoors together with a power generating device such as a solar battery. If the system interconnection inverter is installed outdoors, anti-crime measures would be inadequate and the system interconnection inverter may be stolen. In addition, it is possible that the control program, which is stored in the system interconnection inverter, may be unlawfully read and stolen by a third person. The control program for the system interconnection control is necessary and indispensable when electricity is sold to a power company.

### BRIEF SUMMARY OF THE INVENTION

The object of an aspect of the present invention is to provide a system interconnection inverter which is capable of preventing theft of the system interconnection inverter or theft of a control program that is stored in the system interconnection inverter.

According to an aspect of the present invention, there is provided a system interconnection inverter which converts an output of a solar battery to an AC and outputs the AC to a commercial power supply system in a system-interconnection fashion, comprising: a housing which is installed outdoors and accommodates the system interconnection inverter; a volatile memory unit which is provided in the housing; an operation device which is provided indoors, instructs driving/stop of the system interconnection inverter, and stores a control program for controlling the system interconnection inverter; and a control unit which is accommodated in the housing, downloads the control program, which is stored in the operation device, each time the system interconnection inverter is booted up, stores the downloaded control program in the memory unit, and controls the system interconnection inverter on the basis of the control program stored in the memory unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a front side view of a housing of each of embodiments of the invention;

FIG. 2 is a too view of the housing of each of the embodiments;

FIG. 3 is a block diagram of a control circuit and its peripheral parts in each of the embodiments;

FIG. 4 shows a remote-control type operation device in each of the embodiments;

FIG. 5 is a block diagram showing the structures of an MCU and an operation device according to a first embodiment of the invention;

FIG. 6 is a flow chart illustrating the operation of the first embodiment;

FIG. 7 is a block diagram showing the structures of an MCU and an operation device according to a second embodiment;

FIG. 8 is a block diagram showing the structures of an MCU and an operation device according to a third embodiment;

FIG. 9 is a flow chart illustrating the operation of the third embodiment; and

FIG. 10 is a flow chart illustrating the operation of a fourth embodiment.

### DETAILED DESCRIPTION OF THE INVENTION

[1] A First Embodiment of the Present Invention will now be Described with Reference to the Accompanying Drawings.

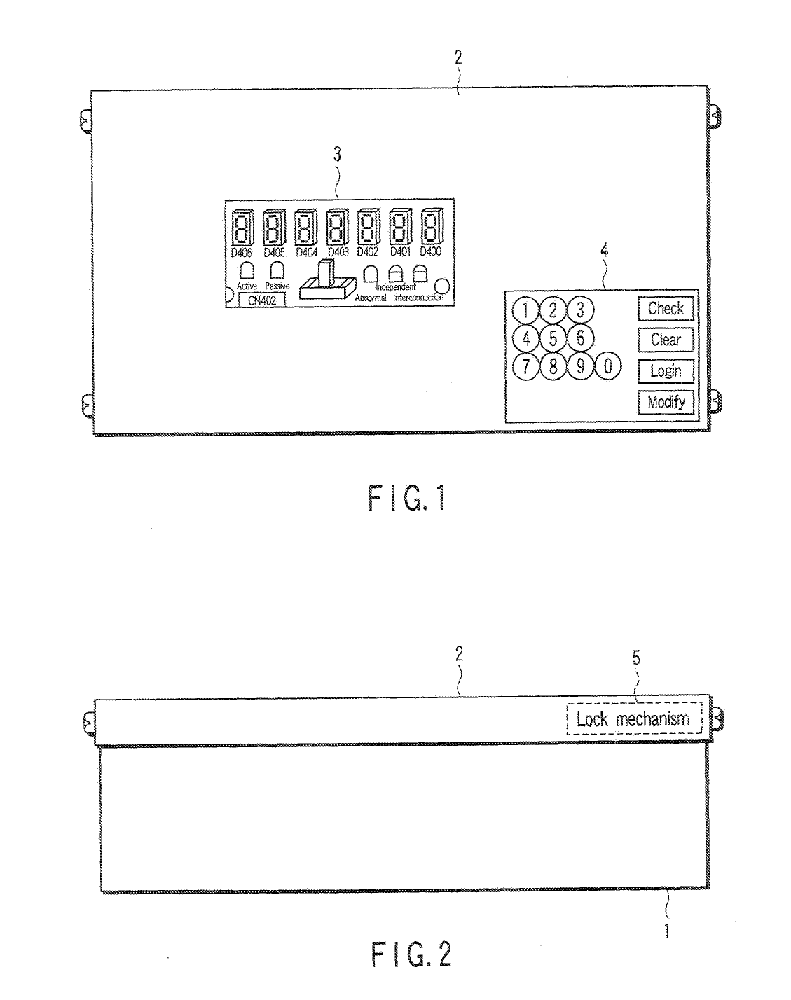

FIG. 1 and FIG. 2 show a box-shaped housing 1 in which a system interconnection inverter of the embodiment is accommodated. FIG. 1 is a front side view, and FIG. 2 is a top side view. The housing 1 is installed and fixed outdoors, for example, on the outside wall of a house.

The front side of the housing 1 has an opening, and a cover 2 is openably provided on the opening. In usual cases, the cover 2 in the closed state is fixed to the housing 1 by means of bolts. An operation display unit 3 and a key input pad 4 are provided on the front surface of the cover 2. The operation display unit 3 includes operation change-over switches arid a display. The key input pad 4 is used to input secret data (password, ID number, etc.) that is necessary in order to open/close a lock mechanism (also referred to as “electronic lock”) which is provided inside the cover 2. The key input pad 4 includes number keys, a check button, a clear button, a login button and a modify button.

If the secret data is input by the number keys and the check button is pressed, it is checked whether the input secret data agrees with pre-registered secret data (stored in an EEPROM 42 (to be described later)). If the input data agrees with the pre-registered data, the locking of the lock mechanism 5 is released.

If the secret data is input by the number keys and the login button is pressed, it is checked whether the input secret data agrees with pre-registered secret data. If the input data agrees with the pre-registered data, update of the pre-registered secret data is permitted. If new secret data is input by the number keys in this state and then the modify button is pressed, the pre-registered secret data is updated to the new secret data.

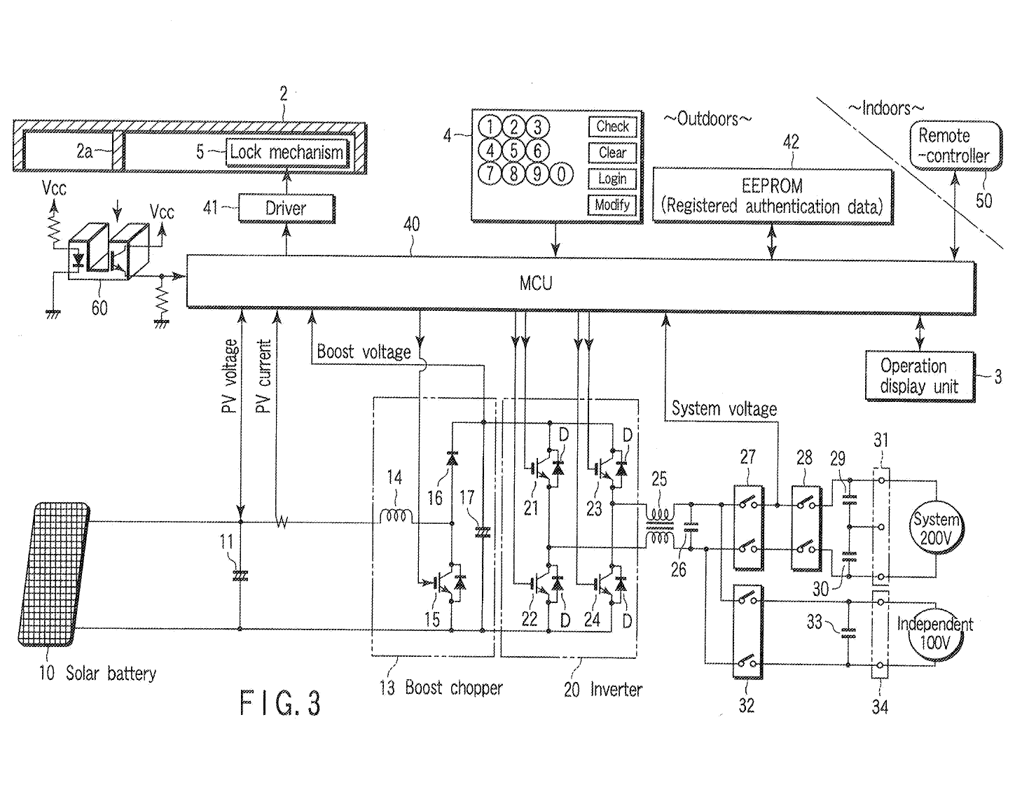

FIG. 3 shows the system interconnection inverter and its peripheral parts, which are accommodated in the housing 1.

A solar battery (PV) 10 is installed, for example, on the roof of the house. Upon receiving light, the solar battery 10 outputs a DC voltage. The output DC voltage is applied to a capacitor 11, and the voltage of the capacitor 11 is supplied to a boost chopper 13. The boost chopper 13 is a so-called DC-DC converter, which includes a DC reactor 14, a transistor, e.g. an IGBT 15, a reverse-current preventing diode 16, and a capacitor 17. The IGBT 15 is turned on/off in accordance with a PWM signal of a predetermined cycle, which is supplied from an MCU 40 that is a control unit. Thereby, the input voltage (DC voltage) is boosted un to a DC voltage of a predetermined level. The boosted output is supplied to an inverter 20. The inverter 20 includes a full-bridge circuit which is composed of four transistors, e.g. IGBTs 21, 22, 23 and 24, and free-wheel diodes D which are connected to the IGBTs 21, 22, 23 and 24 in a reverse parallel fashion. The IGBTs 21, 22, 23 and 24 are turned on/off in accordance with PWM signals from the MCU 40, and thereby the inverter 20 converts the input voltage (DC voltage) to an AC voltage corresponding to the voltage and frequency of a commercial power supply system (to be described later).

An output terminal of the inverter 20 is connected to an AC reactor 25 and a capacitor 26, which function as a noise filter. The capacitor 26 is connected to first switch means, i.e. relay contacts 27 and 28, and to a system output terminal (100V/200V) 31 via output capacitors 29 and 30. A commercial power supply system (single-phase three-wire AC 200V) is connected to the system output terminal 31. Various electric devices are connected to the commercial power supply system.

In addition, the capacitor 26 is connected to second switch means, i.e. a relay contact 32, and to an independent driving output terminal (100V) 34 via an output capacitor 33. The independent driving output terminal 34 enables the driving of the various electric devices in a case where the commercial power supply system is shut off due to a disaster or electric power outage. At the time of the independent driving, the relay contact 27 is opened, and the relay contact 32 is closed.

The MCU 40 controls the relay contacts 27, 28 and 32. In addition, the MCU 40 controls and monitors a system voltage on a current path between the relay contact 27 and relay contact 28 and the frequency of this system voltage, an output voltage and an output current of the solar battery 10, and a boost voltage of the boost chopper 13.

The operation display unit 3, key input pad 4, a driver 41, EEPROM 42, a remote-control operation device (it is called a remote-controller) 50 and a detector 60 are connected to the MCU 40. The driver 41 is, e.g. a motor for opening/closing the lock mechanism 5 of the cover 2. The EEPROM 42 stores secret data that is necessary for opening/closing the lock mechanism 5.

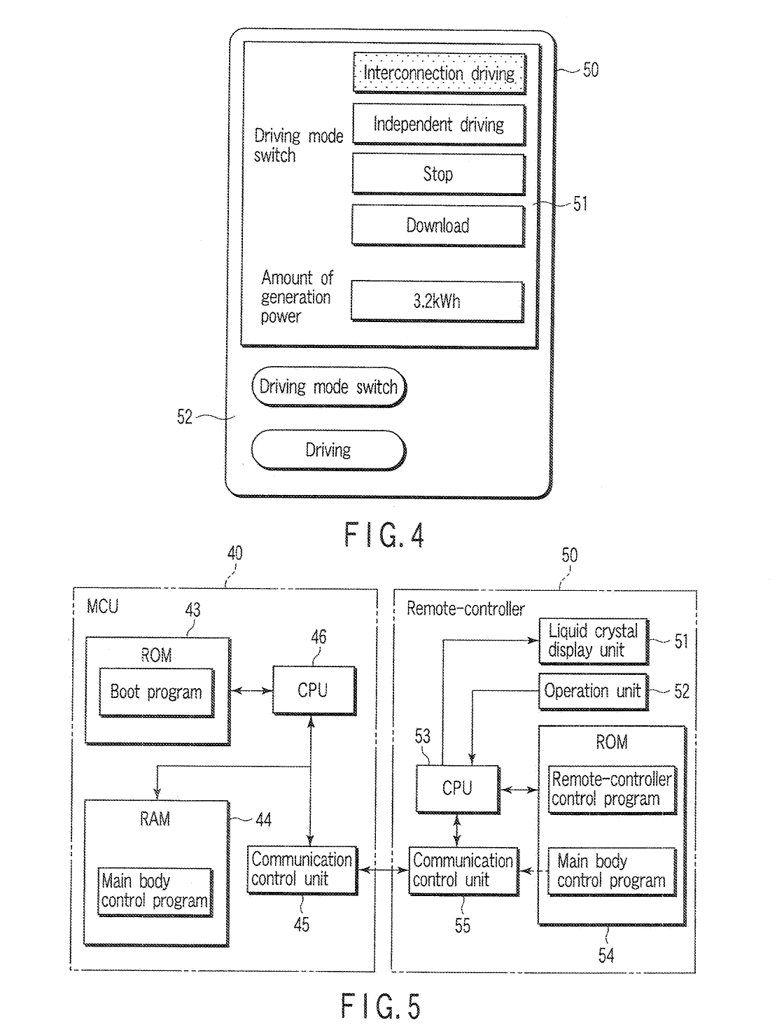

The remote-controller 50 is installed indoors. As shown in FIG. 4, the remote-controller 50 includes a liquid crystal display unit 51 and an operation unit 52. The remote-controller 50 is connected to the system interconnection inverter over a signal line. The remote-controller 50 instructs the driving/stop of the system interconnection inverter, and stores a control program that is necessary for the control of the MCU 40. Each time a driving switch button of the operation unit 52 is pressed, the driving mode of the remote-controller 50 is switched. The driving modes of the operation device are “interconnection driving”, “independent driving”, “stop”, and “download”. In the case where the interconnection driving mode is set, the characters “INTERCONNECTION DRIVING” on the liquid crystal display unit 51 are lighted. The lighted state is indicated by dots in FIG. 4.

The detector 60 is a photo-coupler which optically detects entrance/exit of a partition plate 2a which is provided inside the cover 2.

FIG. 5 shows the structures of main parts of the MCU 40 and remote-controller 50.

The MCU 40 includes a ROM 43, a RAM 44 that is a volatile memory unit, a communication control unit 45 and a CPU 46. The ROM 43 stores a boot program that is necessary for boot-up of the system interconnection inverter. The RAM 44 is used to store a control program that is necessary for the control of the system interconnection inverter. The CPU 46 controls the ROM 43, the RAN 44 and the communication control unit 45.

The remote-controller 50 includes a CPU 53, a ROM 54 and a communication control unit 55, in addition to the liquid crystal display unit 51 and operation unit 52. The ROM 54 stores an operation device control program that is necessary for the operation of the remote-controller 50, and a control program that is necessary for the control of the MCU 40.

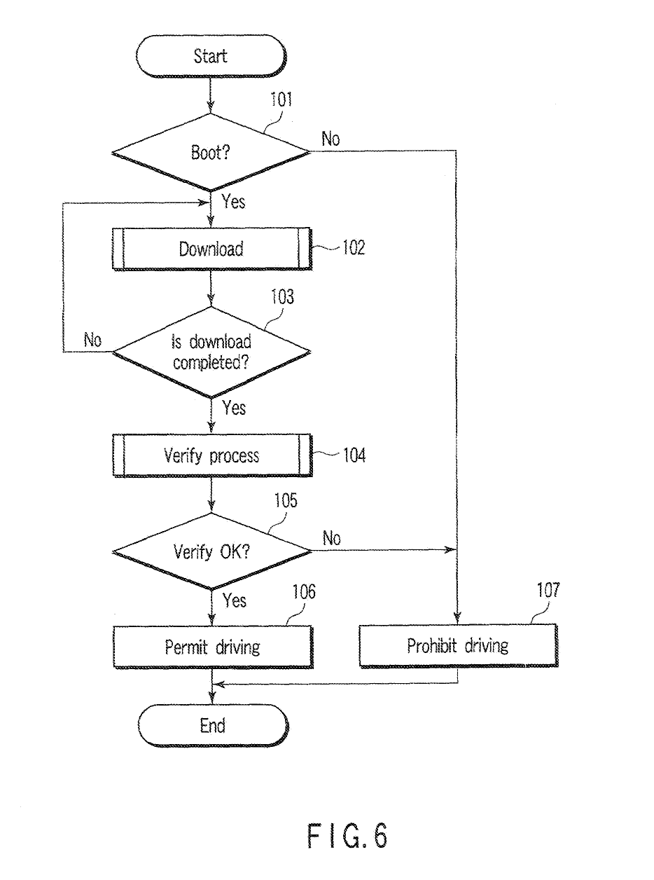

Next, the operation of the above-described structure is described with reference to a flow chart of FIG. 6.

If the system interconnection inverter is booted up by the operation of the remote-controller 50 (YES in step 101), the control program that is stored in the ROM 54 of the remote-controller 50 is downloaded at high speed and stored in the RAM 44 of the MCU 40 via the communication control units 55 and 45, as indicated by broken lines in FIG. 5 (step 102). If the download is completed (YES in step 103), a verify process is executed to check whether there is an error in the downloaded control program (step 104). If no error is found in the verify process (YES in step 105), the driving of the system interconnection inverter by the control of the MCU 40 is permitted (step 106). If an error is found in the verify process (NO in step 105), the driving is prohibited (step 107).

In this manner, each time the system interconnection inverter is booted up, the control program in the remote-controller 50 is downloaded and stored in the RAM 44 in the main body side. When the system interconnection inverter is halted, power supply to the RAM 44 is stopped and the control program in the RAM 44 is lost.

Thus, when the system interconnection inverter is halted, the control program is not present in the RAM 44 even if a third person attempts to unlawfully read the control program from the RAM 44. Therefore, the control program is not stolen. In the meantime, the control program, which is downloaded from the remote-controller 50, may be the complete programs which control the operation of the system interconnection inverter, or may be some important programs.

[2] A Second Embodiment of the Invention is Described.

As shown in FIG. 7, the ROM 54 of the remote-controller 50 stores an operation device control program that is necessary for the operation of the remote-controller 50, a control program that is necessary for the control of the MCU) 40, and control data (e.g. various parameters) that is necessary for the control of the MCU 40.

In this case, each time the system interconnection inverter is booted up, the control program and the control data in the remote-controller 50 are downloaded and stored in the RAM 44 in the main body side, as indicated by broken lines in FIG. 7. When the system interconnection inverter is halted, the control program and control data in the RAM 44 are lost.

Thus, when the system interconnection inverter is halted, the control program and control data are not present in the RAM 44 even if a third person attempts to unlawfully read the control program control data from the RAM 44. Therefore, the control program and control data are not stolen.

The other structure, operation and advantageous effects of the second embodiment are the same as those of the first embodiment. Thus, the description thereof is omitted here.

[3] A Third Embodiment of the Invention is Described.

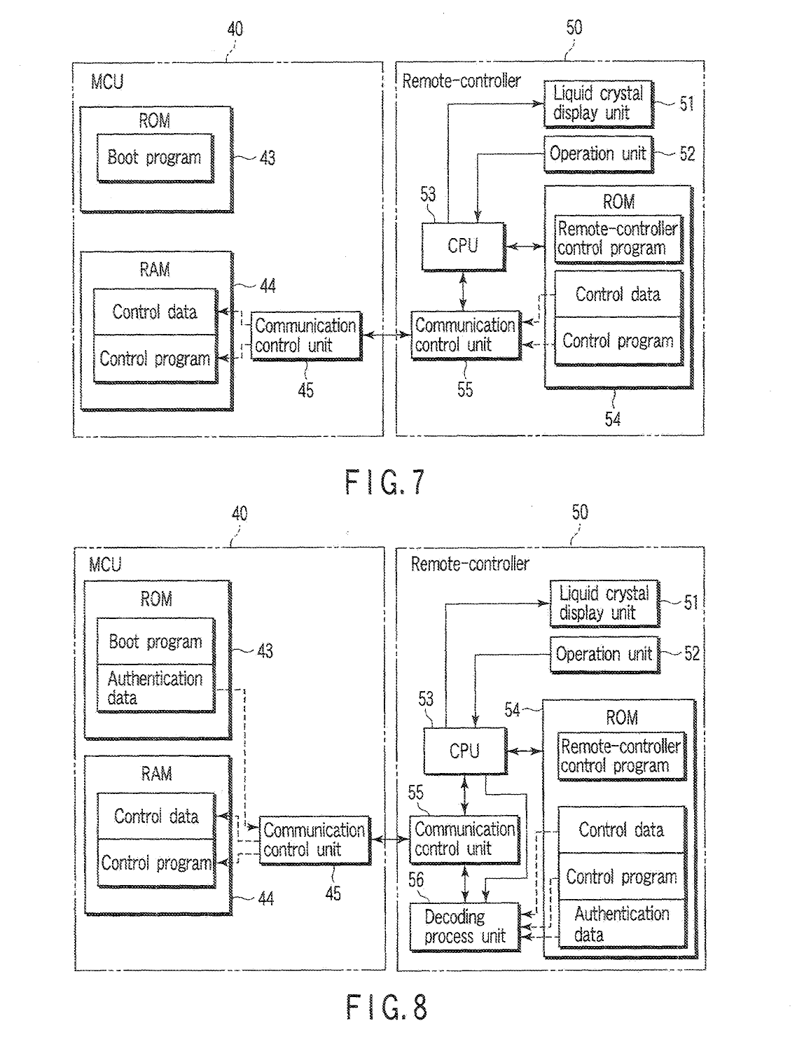

As shown in FIG. 8, the ROM 43 of the MCU 40 stores authentication data (product number, model number, etc.) of the system interconnection inverter. The same authentication data is also stored in the ROM 54 of the remote-controller 50.

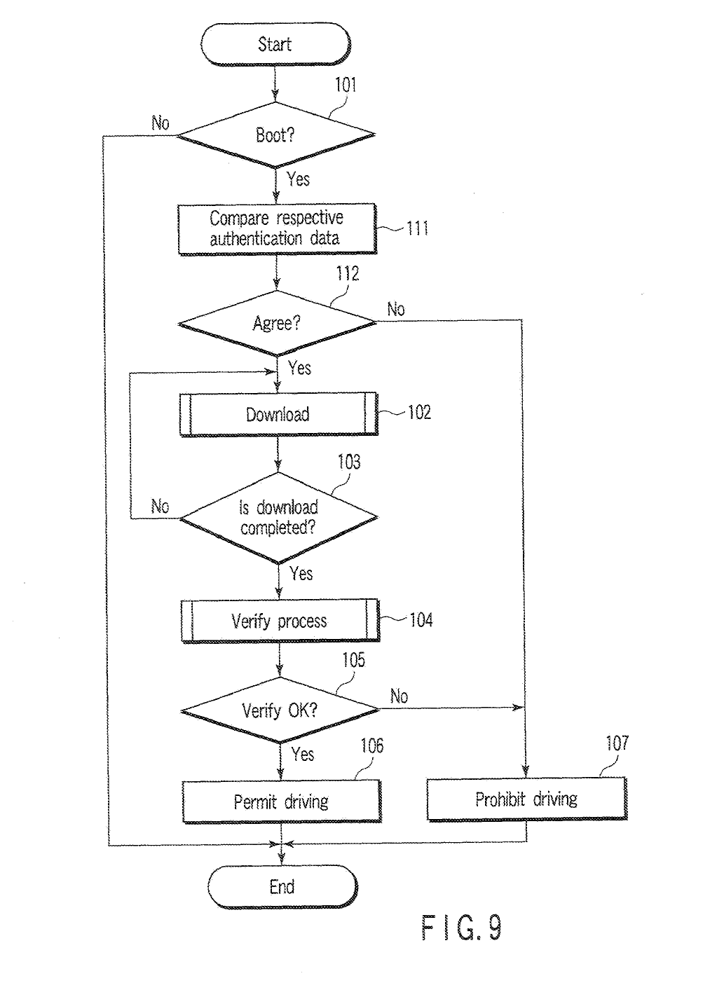

In this case, as illustrated in a flow chart of FIG. 9, if the system interconnection inverter is booted up (YES in step 101), authentication data is read out of the ROM 43 of the MCU 40 and the read-out authentication data is sent to the remote-controller 50 via the communication control unit 45 and communication control unit 55. The CPU 53 of the remote-controller 50 reads out authentication data from the ROM 54 of the remote-controller 50, decodes the read-out authentication data by a decoding process unit 56, and compares the decoded authentication data with the authentication data that is sent from the MCU 40 (step 111).

If the compared authentication data agree with each other (YES in step 112), the CPU 53 of the remote-controller 50 reads out the control program and control data from the ROM 54, decodes the read-out control program and control data by the decoding process unit 56, and sends them to the MCU 40 at high speed. Thus, the control program and control data are downloaded and stored in the RAM 44, as indicated by broken lines (step 102).

If the compared authentication data do not agree (NO in step 112), the CPU 53 of the remote-controller 50 does not read out the control program and control data from the ROM 54, and prohibits the driving (step 107).

The agreement of the compared authentication data is the condition for permitting the download. Thereby, the control program and control data in the remote-controller 50 are prevented from being unlawfully downloaded into an external device other than the system interconnection inverter, such as a personal computer.

The other structure, operation and advantageous effects of the third embodiment are the same as those of the first and second embodiments, and so the detailed description thereof is omitted here.

[4] A Fourth Embodiment of the Invention is Described.

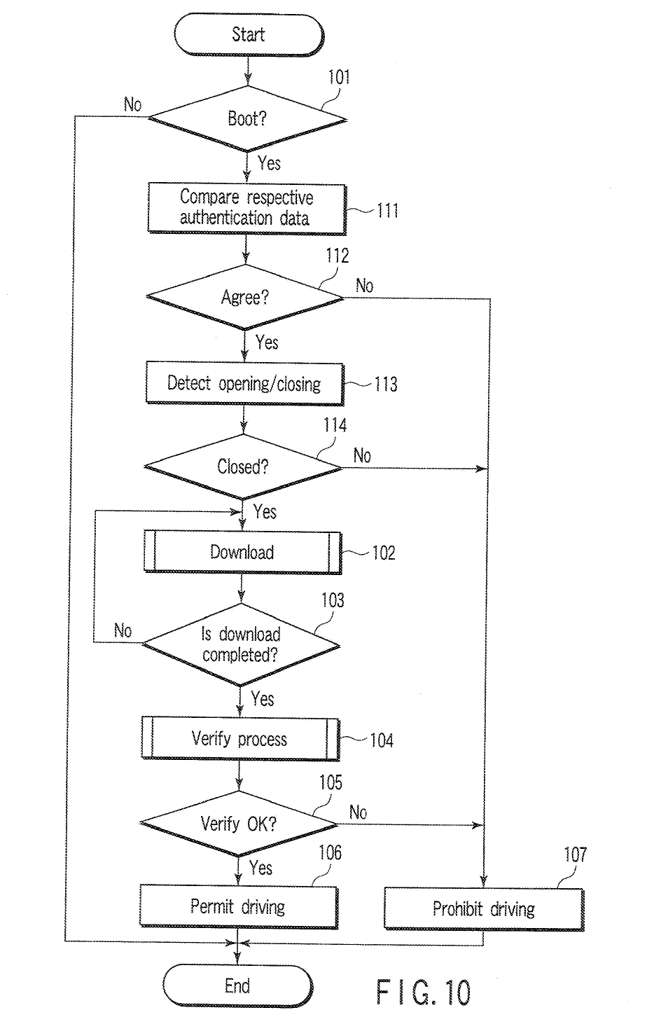

As illustrated in a flow chart of FIG. 10, if the system interconnection inverter is booted up (YES in step 101), the authentication data is read out of the ROM 43 of the MCU 40 and also the authentication data is read out of the ROM 54 of the remote-controller 50, and both authentication data are compared (step 111.

If the compared authentication data agree (YES in step 112), the detector 60 detects whether the cover 2 of the housing 1 is closed or not (step 113). If the cover 2 is closed (YES in step 113), the control program and control data are read out of the ROM 54 of the remote-controller 50 and then downloaded and stored in the RAM 44 of the MCU 40 (step 102).

If the compared authentication data do not agree (NO in step 112) or if the cover 2 is opened (NO in step 114), the download is not executed and the driving is prohibited (step 107).

Since the agreement of the compared authentication data and the closing of the cover 2 are the conditions for permitting the download, the control program and control data in the remote-controller 50 can be prevented, with high security, from being unlawfully downloaded into an external device.

The other structures operation and advantageous effects of the fourth embodiment are the same as those of the first, second and third embodiments. Thus, the detailed description thereof is omitted here.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A system interconnection inverter which converts an output of a solar battery to an AC and outputs the AC to a commercial power supply system in a system-interconnection fashion, comprising:
a housing which is installed outdoors and accommodates the system interconnection inverter;
a volatile memory unit which is provided in the housing;
an operation device which is provided indoors, instructs driving/stop of the system interconnection inverter, and stores a control program for controlling the system interconnection inverter; and
a control unit which is accommodated in the housing, downloads the control program, which is stored in the operation device, each time the system interconnection inverter is booted up, stores the downloaded control program in the memory unit, and controls the system interconnection inverter on the basis of the control program stored in the memory unit.

2. The system interconnection inverter according to claim 1, wherein the housing includes an openable/closable cover and a lock mechanism of the cover.

3. The system interconnection inverter according to claim 1 further comprising a detector which detects opening/closing of the cover.

4. The system interconnection inverter according to claim 3, wherein the control unit permits the download in a case where the closing of the cover is detected by the detector, and prohibits the download in a case where the opening of the cover is detected by the detector.

5. The system interconnection inverter according to claim 1, wherein the operation device is a remote-control type operation device.

6. A system interconnection inverter which converts an output of a solar battery to an AC and outputs the AC to a commercial power supply system in a system-interconnection fashion, comprising:
a housing which is installed outdoors and accommodates the system interconnection inverter;
volatile memory means which is provided in the housing;
operation means, provided indoors, for instructing driving/stop of the system interconnection inverter, and storing a control program for controlling the system interconnection inverter; and
control means, accommodated in the housing, for downloading the control program, which is stored in the operation means, each time the system interconnection inverter is booted up, storing the downloaded control program in the memory means, and controlling the system interconnection inverter on the basis of the control program stored in the memory means.

7. The system interconnection inverter according to claim 6, wherein the housing includes an openable/closable cover and a lock mechanism of the cover.

8. The system interconnection inverter according to claim 6, further comprising detection means for detecting opening/closing of the cover.

9. The system interconnection inverter according to claim 8, wherein the control means permits the download in a case where the closing of the cover is detected by the detection means, and prohibits the download in a case where the opening of the cover is detected by the detection means.

10. The system interconnection inverter according to claim 6, wherein the operation means is a remote-control type operation device.
